(19) United States
(12) Patent Application Publication
(10) Pub. No.: US 2009/0214273 A1
(43) Pub. Date: Aug. 27, 2009

(54) Image Forming Apparatus

(75) Inventor: Hiroshi Ue, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/393,629

(22) Filed: Feb. 26, 2009

(30) Foreign Application Priority Data
Feb. 27, 2008 (JP) 2008-045574

(51) Int. Cl. G03G 15/01

(52) U.S. Cl. 399/302

(57) ABSTRACT

An image forming apparatus includes an intermediate transfer belt having an insulating substrate layer, an electrode layer provided on the insulating substrate layer, and a semiconductor layer provided on the electrode layer; a transfer-voltage applying device that applies a predetermined bias voltage to the electrode layer of the intermediate transfer belt; and a secondary transfer roller which is in contact with the outer circumference of the intermediate transfer belt to form a nip region and to which a predetermined bias voltage is applied. The image forming apparatus has not a member that opposes the secondary transfer roller to nip the intermediate transfer belt therebetween.

### BACKGROUND

1. Technical Field

The present invention relates to an image forming apparatus that develops a latent image formed on an image bearing member with a toner, transfers the developed toner image on a recording medium such as a sheet material, and finally fuses the developed toner image on the recoding medium by applying heat and pressure with a fixing unit to form a permanent visible image.

2. Related Art

In image forming apparatuses, a secondary transfer section, at which a toner image primarily transferred on an intermediate transfer belt is secondarily transferred, is acted on by an electric field even at a prenip region. This poses the technical problems that a toner image (visible image), for example, on the intermediate transfer belt scatters at the prenip region of the secondary transfer region to cause so-called blur (an image defect), a discharge mark, and dust, thus causing image degradation.

A postnip region of the secondary transfer section is also acted on by a relatively large electric field. This also poses the technical problem that a linear, so-called discharge mark (image defect) due to separating discharge is prone to occur during separating of paper, thus degrading image quality. Furthermore, this also poses the problem of degrading paper peeling or separating performance after secondary transfer in consequence of the electric field at the postnip region.

As a solution to the above-described problems, an image forming apparatus having an intermediate transfer belt and a secondary transfer section that employs a secondary transfer roller system is disclosed in JP-A-11-65332. This apparatus disclosed in JP-A-11-65332 is configured to put paper along the intermediate transfer belt before the paper enters a secondary transfer nip region. That is, by putting paper along the belt ahead of a prenip region at which a secondary transfer electric field starts to be applied, generation of a discharge mark and dust is reduced before secondary transfer.

An apparatus disclosed in JP-A-10-288903 is configured such that a secondary transfer section at which an image is transferred from an intermediate transfer member to paper has two conductive members (secondary transfer rollers). It is configured such that, if one of the secondary transfer rollers receives a bias voltage, a current flows from the one secondary transfer roller through a secondary transfer backup member to the other secondary transfer roller. That is, it is configured to be able to switch application of a bias voltage between the prenip side and the postnip side. Thus, this apparatus solves the problems of dust and a discharge mark at the prenip region and a discharge mark at the postnip region by switching the rollers to which a bias voltage is applied.

However, the apparatus disclosed in JP-A-11-65332 needs a backup roller having a voltage applying device for secondary transfer and cannot reduce discharge caused during separating paper after transfer (at the postnip region) although discharge before transfer (at the prenip region) is prevented. This cannot be solved by the secondary transfer that needs a backup roller.

Since the apparatus disclosed in JP-A-11-65332 reduces an electric field at the prenip region while ensuring a current path by making half of the secondary transfer roller contact with the belt in a lapping manner and making the remaining half contact with the backup roller in an abutting manner, high positional accuracy is required for the secondary transfer roller, which may cause an increase in cost. Furthermore, without a relatively large-diameter secondary transfer roller, the prenip region is in contact with the secondary transfer electric field, which also causes a limitation in secondary transfer roller diameter. Thus, the configuration disclosed in JP-A-11-65332 is not suitable for reducing discharge at the secondary transfer postnip region and is not the most suitable in terms of cost although it is suitable for reducing a discharge mark and dust at the prenip region.

The configuration disclosed in JP-A-10-288903 needs two rollers, which is disadvantageous in terms of cost when including peripheral members. This also has a problem of stability in paper transportation. Since paper that has passed through the first roller needs to be transported along the arc shape of a secondary transfer backup member and enter the second roller, it is difficult to hold the paper.

### SUMMARY

Advantages of some aspects of the invention are to prevent, at a prenip region, a toner image (visible image) on an intermediate transfer belt from scattering to cause so-called blur (an image defect) and to prevent generation of a discharge mark and dust to cause image degradation and also to prevent, at a postnip region, a linear, so-called discharge mark (image defect) due to separating discharge during separation of paper to cause image degradation. Another advantage is to prevent paper peeling or separating performance at the postnip region after secondary transfer. Accordingly, an image forming apparatus according to an aspect of the invention includes an intermediate transfer belt having an insulating substrate layer, an electrode layer provided on the insulating substrate layer, and a semiconductor layer provided on the electrode layer; a transfer-voltage applying device that applies a predetermined bias voltage to the electrode layer of the intermediate transfer belt; and a secondary transfer roller which is in contact with the outer circumference of the intermediate transfer belt to form a nip region and to which a predetermined bias voltage is applied. The image forming apparatus has not a member that opposes the secondary transfer roller to nip the intermediate transfer belt therebetween.

It is preferable that paper be transported, at a prenip region upstream from the nip region, along the intermediate transfer belt.

It is preferable that the image forming apparatus further include a corona charger upstream from the nip region.

It is preferable that the image forming apparatus further include a paper guide, upstream from the nip region, that guides paper to the intermediate transfer belt.

It is preferable that the direction of the curl of paper at the nip region be a direction away from the intermediate transfer belt.

It is preferable that the image forming apparatus further include a separator, downstream from the nip region, that separates paper from the intermediate transfer belt.

It is preferable that the image forming apparatus further include a driving roller that drives the intermediate transfer belt; and the separator be disposed at a position at which it nips the intermediate transfer belt with the driving roller.

It is preferable that the image forming apparatus further include a tension roller upstream from the paper guide and downstream from a position at which a final-color toner image is formed on the intermediate transfer belt.

The image forming apparatus according to some aspects of the invention prevents, at a prenip region, a toner image (visible image) on an intermediate transfer belt from scattering to cause so-called blur (an image defect) and prevents generation of a discharge mark and dust to cause image degradation and also prevents, at a postnip region, a linear, so-called discharge mark (image defect) due to separating discharge during separation of paper to cause image degradation, without much cost. Furthermore, the image forming apparatus according to some aspects of the invention can improve paper peeling or separating performance at the postnip region after secondary transfer.

### BRIEF DESCRIPTION OF THE DRAWINGS

The invention will be described with reference to the accompanying drawings, wherein like numbers reference like elements.

FIG. 1 is a sectional view showing the schematic configuration of an image forming apparatus according to an embodiment of the invention.

FIG. 2 is a cross-sectional view of an intermediate transfer belt used in the image forming apparatus according to the embodiment of the invention.

FIG. 3 is a diagram showing a secondary transfer section of the image forming apparatus according to the embodiment of the invention.

FIG. 4 is a diagram showing the secondary transfer section of the image forming apparatus according to the embodiment of the invention.

FIG. 5 is a sectional view showing the schematic configuration of an image forming apparatus according to another embodiment of the invention.

### DESCRIPTION OF EXEMPLARY EMBODIMENTS

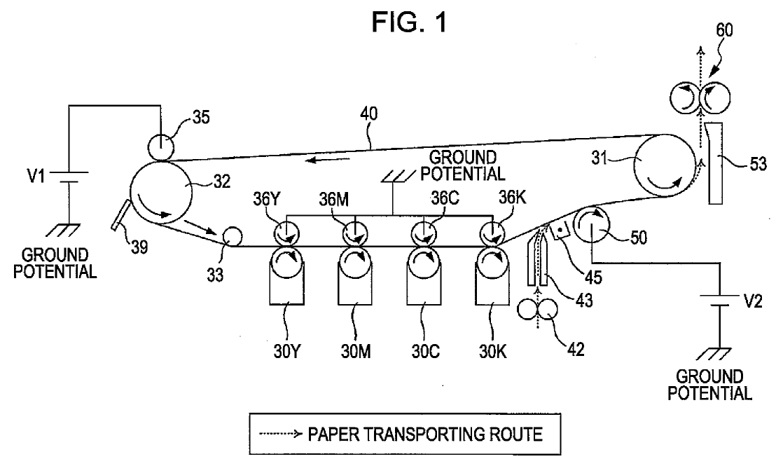

An embodiment of the invention will be described with reference to the drawings. FIG. 1 is a sectional view showing the overall schematic configuration of a tandem-type image forming apparatus according to an embodiment of the invention.

Referring to FIG. 1, reference numerals 20Y, 20M, 20C, and 20K denote photosensitive drums (image bearing members); 30Y, 30M, 30C, and 30K denote process cartridges; 31 denotes a driving roller; 32 denotes a driven roller; 33 denotes a first tension roller; 35 denotes a transfer-bias-voltage applying device; 36Y, 36M, 36C, and 36K denote backup rollers; 39 denotes an intermediate-transfer-belt cleaning blade; 40 denotes an intermediate transfer belt; 42 denotes a feed roller pair; 43 denotes a first paper guide; 45 denotes a corona charger; 50 denotes a secondary transfer roller; 53 denotes a second paper guide; and 60 denotes a fixing roller pair.

The process cartridges 30Y (yellow), 30M (magenta), 30C (cyan), and 30K (black) have the photosensitive drums (latent-image bearing members) 20Y, 20M, 20C, and 20K, respectively, on the individual surfaces of which electrostatic latent images according to image information are formed with rotation by a known electrophotographic process of a charger or the like. Developing units corresponding to the colors, yellow (Y), magenta (M), cyan (C), and black (K), are disposed around the photosensitive drums 20Y, 20M, 20C, and 20K. Electrostatic latent images formed on the photosensitive drums 20Y, 20M, 20C, and 20K are developed by the individual developing units to form toner images. Accordingly, if an electrostatic latent image written on the photosensitive drum 20Y corresponds to yellow image information, this electrostatic latent image is developed by a developing unit containing a yellow toner, so that a yellow toner image is formed on the photosensitive drum 20Y.

The endless intermediate transfer belt 40 is disposed in contact with the surfaces of the respective photosensitive drums 20Y, 20M, 20C, and 20K of the process cartridges 30Y, 30M, 30C, and 30K.

The intermediate transfer belt 40 is stretched round a plurality of rollers including the first tension roller 33 that holds the tension of the intermediate transfer belt 40 constant and the driven roller 32. As the driving roller 31 provided with a driving source (not shown) rotates, the intermediate transfer belt 40 rotates in the direction of the arrow in FIG. 1.

Toner images formed on the photosensitive drums 20Y, 20M, 20C, and 20K of the process cartridges 30Y, 30M, 30C, and 30K are transferred, at a first transfer position at which the photosensitive drums 20Y, 20M, 20C, and 20K and the intermediate transfer belt 40 are in contact with each other, from the photosensitive drums 20Y, 20M, 20C, and 20K to the surface of the intermediate transfer belt 40.

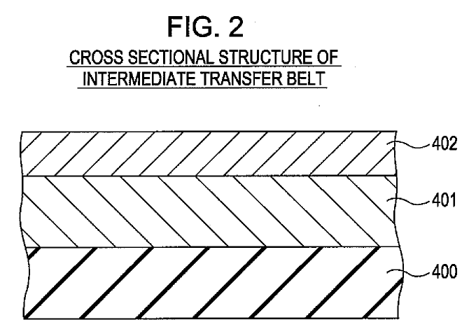

Here, the intermediate transfer belt 40 used in the image forming apparatus according to the embodiment will be described in more detail. FIG. 2 is a cross-sectional view of the intermediate transfer belt 40 used in the image forming apparatus according to the embodiment of the invention. As shown in FIG. 2, the intermediate transfer belt 40 of this embodiment has a three-layer structure in which an electrode layer 401 made of aluminum or the like is provided on an insulating substrate layer 400 made of polyethylene terephthalate (PET), on the surface of which a semiconductor layer (paint) 402 is formed. A belt-like portion having no semiconductor layer 402 is partially formed along one end in the width direction to form an electrode-layer-401 exposed portion. The electrode-layer-401 exposed portion is formed so as to extend along the entire circumference of the endless intermediate transfer belt 40. The transfer-bias-voltage applying device 35 is in contact with the electrode layer 401 to apply a predetermined transfer bias voltage V1 to the electrode layer 401. The order of the volume resistivity of the semiconductor layer 402 is about 10⁶ to 10¹² Ωcm.

The transfer-bias-voltage applying device 35 is disposed at a position at which it nips the intermediate transfer belt 40 with the opposing driven roller 32 and applies the predetermined transfer bias voltage V1 to the electrode layer 401 while pushing the intermediate transfer belt 40.

The transfer-bias-voltage applying device 35 may be constituted by a conductive roller or rigid contact that is driven and rotated in contact with the electrode layer 401 of the intermediate transfer belt 40, a conductive elastic member such as a plate spring, or a conductive brush formed of resin fibers or the like.

The backup rollers 36Y, 36M, 36C, and 36K are disposed, at the first transfer position, on the inner circumferential surface of the intermediate transfer belt 40. The backup rollers 36Y, 36M, 36C, and 36K are grounded so as to have a grounded potential. The backup rollers 36Y, 36M, 36C, and 36K are disposed so as to nip the intermediate transfer belt 40 with the photosensitive drums 20Y, 20M, 20C, and 20K.

The toner images on the photosensitive drums 20Y, 20M, 20C, and 20K are attracted to the intermediate transfer belt 40 by the action of the transfer bias voltage V1 applied to the electrode layer 401 of the intermediate transfer belt 40 and are electrostatically transferred on the surface of the intermediate transfer belt 40. The individual color toner images are transferred on top of one another on the intermediate transfer belt 40, so that a full-color toner image is formed on the intermediate transfer belt 40.

Paper picked up from a paper feed cartridge (not shown) is transported while passing between the feed roller pair 42 and, as shown in FIG. 1, passes the first paper guide 43 provided upstream from a nip region at which the secondary transfer roller 50 and the intermediate transfer belt 40 are in contact with each other and advances toward the secondary transfer roller 50 along the intermediate transfer belt 40 at the prenip region. The dotted arrow shown in FIG. 1 indicates a paper transporting route.

The corona charger 45 is a charging device, such as a scorotron or a corotron and, as shown in FIG. 1, is provided upstream from the nip region at which the secondary transfer roller 50 and the intermediate transfer belt 40 are in contact. This generates positive corona discharge to cause paper to affix to the intermediate transfer belt 40 at the preliminary step to secondary transfer and to advance the paper to the nip region at which the secondary transfer roller 50 and the intermediate transfer belt 40 are in contact. The paper is transported in synchronism with a toner image transferred on the intermediate transfer belt 40.

Components, such as rollers, disposed at the previous stage of the beginning to the end of the image forming process is defined to be located upstream from components, such as rollers, located at the downstream stage. A part in the vicinity of the nip region at which the secondary transfer roller 50 and the intermediate transfer belt 40 are in contact and substantially upstream from the nip region is defined as “a prenip region”; and a part in the vicinity of the nip region of the secondary transfer roller 50 and the intermediate transfer belt 40 and substantially downstream from the nip region is defined as “a postnip region”.

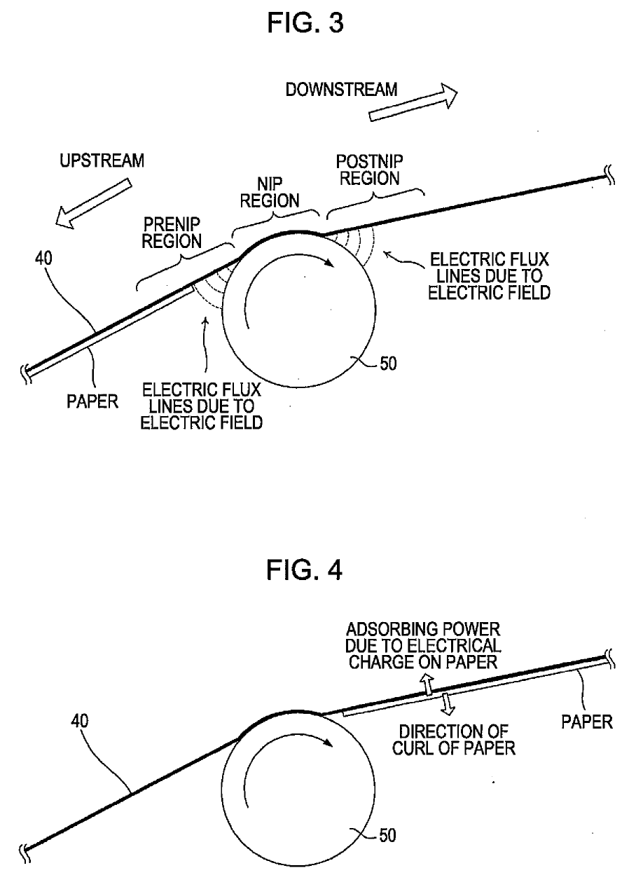

Next, secondary transfer of the image forming apparatus according to the embodiment of the invention will be described in detail. FIG. 3 is a diagram showing a secondary transfer section of the image forming apparatus according to the embodiment of the invention. A toner image transferred on the intermediate transfer belt 40 and paper affixed thereto advance to the nip region at which the secondary transfer roller 50 and the intermediate transfer belt 40 are in contact. The secondary transfer roller 50 is in contact with the intermediate transfer belt 40 in such a manner as to recess the outer circumference of the intermediate transfer belt 40. The image forming apparatus according to the embodiment of the invention is not provided with a so-called backup member or the like that is disposed so as to face the secondary transfer roller 50 and to nip the intermediate transfer belt 40 at the position at which the secondary transfer roller 50 is in contact with the intermediate transfer belt 40.

The secondary transfer roller 50 receives a predetermined bias voltage V2, whereas the electrode layer 401 of the intermediate transfer belt 40 receives the transfer bias voltage V1 from the transfer-bias-voltage applying device 35, as described above, so that the toner image on the intermediate transfer belt 40 is attracted and transferred to the paper due to the potential difference between the bias voltage V2 and the bias voltage V1.

In the image forming apparatus according to the embodiment of the invention, the secondary transfer roller 50 is in contact with the intermediate transfer belt 40 in such a manner as to recess the outer circumference of the intermediate transfer belt 40; the secondary transfer roller 50 receives the bias voltage V2; and the intermediate transfer belt 40 receives the bias voltage V1, wherein the electric flux lines of the electric field due to the potential difference therebetween is shown in FIG. 3. With the positional relationship and application of the bias voltages as in the invention, the gap formed between the secondary transfer roller 50 and the intermediate transfer belt 40 can be reduced, and the gap formed between the intermediate transfer belt 40 and paper can also be reduced, and thus the degree of influence of the electric field on the paper is decreased.

In the case of the related-art image forming apparatuses, a secondary transfer section is configured such that a secondary transfer roller and a secondary transfer backup roller nip an intermediate transfer belt, and a bias voltage is applied between the secondary transfer roller and the secondary transfer backup roller to transfer a toner image onto paper. Such positional relationship and application of bias voltages cause an influence of an electric field on paper. However, with the positional relationship and application of bias voltages according to the embodiment of the invention, the degree of influence of the electric field formed between the secondary transfer roller 50 and the intermediate transfer belt 40 on the paper can be decreased. Therefore, with the configuration of the image forming apparatus according to the embodiment of the invention, there is no need for a backup member, which prevents, without much cost, a toner image (visible image) on the intermediate transfer belt 40 from scattering at the prenip region due to electric discharge to cause so-called blur (an image defect), or generation of a discharge mark or dust to cause image degradation.

The decrease in the influence of the electric field in the image forming apparatus according to the embodiment of the invention applies not only to the prenip region but also to the postnip region. This configuration can prevent generation of a linear, so-called discharge mark (an image defect) due to separating discharge during the separation of paper at the postnip region to degrade the image quality.

Furthermore, the positional relationship and application of bias voltages of the embodiment of the invention can improve the paper peeling or separating performance at the postnip region. This will be described with reference to FIG. 4. FIG. 4 is a diagram of the secondary transfer section of the image forming apparatus according to the embodiment of the invention. FIG. 4 schematically shows the state of paper at the postnip region. As shown in FIG. 4, the paper at the postnip region is adsorbed to the intermediate transfer belt 40 by adsorbing power due to the electric charge of the paper. The curl of the paper, which is formed because the paper is wound around the secondary transfer roller 50 at the nip region at which the secondary transfer roller 50 and the intermediate transfer belt 40 are in contact, is directed away from the intermediate transfer belt 40, opposite to the adsorption. This improves the peeling or separating performance of paper owing to the balance between the adsorbing direction and the direction of the curl of the paper.

In the related-art image forming apparatuses, paper that passes between the secondary transfer roller and the secondary transfer backup roller at the secondary transfer section is adsorbed to the secondary transfer roller, that is, to the intermediate transfer belt due to electric charge, and the curl of the paper is also directed to the intermediate transfer belt because of the arrangement in which the intermediate transfer belt is wound around the secondary transfer backup roller. Thus, the direction of the adsorption and the direction of the curl of the paper are the same, so that the related-art apparatuses have not preferable peeling or separation performance of paper from the intermediate transfer belt. In contrast, the image forming apparatus according to the embodiment of the invention can improve the peeling or separation performance of paper from the intermediate transfer belt 40 at the postnip region, as described above.

Since the image forming apparatus according to the embodiment of the invention has high peeling or separation performance of paper from the intermediate transfer belt 40, paper can be separated from the intermediate transfer belt 40 by a relatively simple separating mechanism such as a separator (not shown) provided at a position at which it nips the intermediate transfer belt 40 with the driving roller 31 disposed downstream from the nip region. The paper separated from the intermediate transfer belt 40 advances to the fixing roller pair 60 while being guided by the second paper guide 53, and is subjected to a toner-image fixing process by passing through the nip region of the fixing roller pair 60 to form a permanent visible image thereon.

The intermediate-transfer-belt cleaning blade 39 is disposed at a position at which it nips the intermediate transfer belt 40 with the opposing driven roller 32 and cleans toner that remains on the intermediate transfer belt 40 while pushing the intermediate transfer belt 40. The cleaned intermediate transfer belt 40 is transported toward the process cartridge 30Y to receive a toner image by primary transfer again.

The configuration of the image forming apparatus according to the embodiment of the invention can prevent, without much cost, a toner image (visible image) on the intermediate transfer belt from scattering to cause so-called blur (an image defect), or generation of a discharge mark or dust to cause image degradation at the prenip region, and can prevent a linear discharge mark (image defect) due to separating discharge during separation of paper at the postnip region, to cause image degradation. Furthermore, the image forming apparatus according to the embodiment of the invention can improve paper peeling or separating performance at the postnip region after secondary transfer.

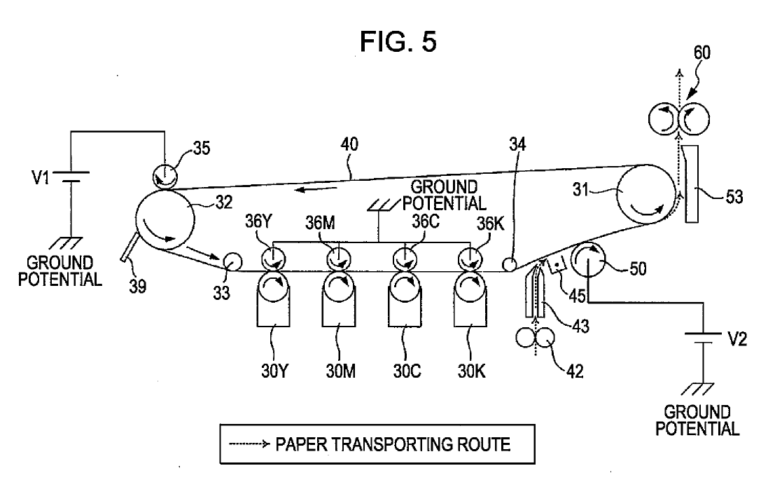

Next, another embodiment of the invention will be described. FIG. 5 is a sectional view showing the schematic configuration of an image forming apparatus according to another embodiment of the invention. This embodiment differs from the foregoing embodiment in that it includes a second tension roller 34 upstream from the first paper guide 43 and downstream from the process cartridge 30K that forms a final-color toner image on the intermediate transfer belt 40. The other configurations are the same between this embodiment and the foregoing embodiment.

Since this embodiment is provided with the second tension roller 34, the degree of recess of the outer circumference of the intermediate transfer belt 40 by the secondary transfer roller 50 can be adjusted. Thus allows the secondary transfer roller 50 and the intermediate transfer belt 40 to be disposed with higher layout flexibility; the effect of reducing the influence of an electric field by the positional relationship and application of bias voltages of the invention can be further increased; and the paper peeling or separating performance can be further improved.

This embodiment of the invention can also provide the same operational advantages as the foregoing embodiment.

The entire disclosure of Japanese Patent Application No. 2008-045574, filed Feb. 27, 2008 is expressly incorporated by reference herein.

What is claimed is:

1. An image forming apparatus comprising:
an intermediate transfer belt including an insulating substrate layer, an electrode layer provided on the insulating substrate layer, and a semiconductor layer provided on the electrode layer;
a transfer-voltage applying device that applies a predetermined bias voltage to the electrode layer of the intermediate transfer belt; and
a secondary transfer roller which is in contact with the outer circumference of the intermediate transfer belt to form a nip region and to which a predetermined bias voltage is applied;
wherein the image forming apparatus has not a member that opposes the secondary transfer roller to nip the intermediate transfer belt therebetween.

2. The image forming apparatus according to claim 1, wherein paper is transported, at a prenip region upstream from the nip region, along the intermediate transfer belt.

3. The image forming apparatus according to claim 1, further comprising a corona charger upstream from the nip region.

4. The image forming apparatus according to claim 1, further comprising a paper guide, upstream from the nip region, that guides paper to the intermediate transfer belt.

5. The image forming apparatus according to claim 1, wherein the direction of the curl of paper at the nip region is a direction away from the intermediate transfer belt.

6. The image forming apparatus according to claim 1, further comprising a separator, downstream from the nip region, that separates paper from the intermediate transfer belt.

7. The image forming apparatus according to claim 1, further comprising:
a driving roller that drives the intermediate transfer belt;
wherein the separator is disposed at a position at which it nips the intermediate transfer belt with the driving roller.

8. The image forming apparatus according to claim 1, further comprising a tension roller upstream from the paper guide and downstream from a position at which a final-color toner image is formed on the intermediate transfer belt.
